(19) United States
(12) Patent Application Publication
(10) Pub. No.: US 2026/0077529 A1
(43) Pub. Date: Mar. 19, 2026

(54) PLANT FOR PROCESSING FOOD PRODUCTS, PLANT SYSTEM AND METHOD FOR CONTROLLING A PLANT FOR PROCESSING FOOD PRODUCTS

(71) Applicant: Weber Food Technology SE & CO. KG, Breidenbach (DE)

(72) Inventor: Ingo ROTHER, Breidenbach (DE)

(21) Appl. No.: 19/136,495

(22) PCT Filed: Nov. 17, 2023
(86) PCT No.: PCT/EP2023/082188

§ 371 Date: Jun. 6, 2025

(30) Foreign Application Priority Data
Dec. 8, 2022 (DE) 10 2022 132 744.2

(51) Int. Cl. B26D 5/00; B26D 7/06; B26D 7/32; B65B 25/06; B65B 57/00

(52) U.S. Cl. CPC B26D 5/007; B26D 7/0616; B26D 7/32; B65B 25/068; B65B 57/00; B26D 2210/02

(57) ABSTRACT

A plant for processing food products comprises at least one processing device and in particular a processing line having a plurality of processing devices connected after one another. Furthermore, the plant comprises a remote control device, which can be positioned spatially separately from the at least one processing device, wherein the remote control device positioned spatially separately from the at least one processing device is configured to change a setting of the at least one processing device in response to a user input.

### RELATED APPLICATION

The present application is a national stage application under 35 U.S. C. § 371 of International Application No. PCT/EP2023/082188, filed 17 Nov. 2023, which claims priority from German Patent Application No. 10 2022 132 744.2, filed 8 Dec. 2022. The above-referenced applications are incorporated by reference.

### SUMMARY

The invention relates to a plant for processing food products, in particular meat products and/or cheese products, that comprises at least one processing device and in particular a processing line having a plurality of processing devices connected after one another.

Such plants may in particular enable an efficient and automatic processing of food products and may, for example, comprise a slicing device by which food products may be automatically cut into slices and portions may be formed from the slices that comprise one or more of the slices. In particular, so-called high-speed slicers may be used for this purpose that may achieve speeds of up to 2000 cuts per minute.

While plants for processing food products generally comprise individual processing devices and may, for example, be configured as a slicing device of the aforementioned kind, such plants may, however, in particular comprise a processing line having a plurality of processing devices connected after one another to be able to carry out consecutive processing steps at the individual processing devices and to be able to achieve a processing that is as complete as possible. For example, plants or their processing lines may have a transport device that adjoins a slicing device and that is configured to take over portions produced by the slicing device and to transport them to a packaging machine of the processing line by which the portions provided may be automatically packaged. In this regard, such a plant having a plurality of processing devices may make it possible to process food products provided at the slicing device into fully packaged portions that may be offered for sale immediately.

In such plants for automatic food processing, it is further generally important to achieve the highest possible product throughput so that high-speed slicers may frequently also be used in the processing lines mentioned. To be able to handle and package portions produced at the speed predefined by the high-speed slicers, transport devices may furthermore be used that have buffer paths for buffering produced portions in order, for example, to be able to compensate for an increased cycle rate of the slicing device compared to a cycle rate of the packaging machine. Such buffered portions may, for example, during a loading pause, during which, after a complete slicing of a food product, a subsequent food product is loaded into the product feed, be brought onto packaging spaces that are provided in the meantime so that a seamless processing of the products may ultimately be achieved.

To bring the portions to the packaging spaces, the transport device may, for example, have a so-called feeder, which may be formed by a transport belt facing in the direction of the packaging machine, or so-called picker robots may be provided that are configured to grip portions and to bring said portions to the packaging spaces. Such a feeder or a picker robot must in this respect also be coordinated with the slicing device and the packaging machine such that the portions may be precisely brought onto the provided packaging spaces.

In particular, such plants having a processing line may thus have a relatively complex structure and, in order to achieve the desired product throughput, it is in particular necessary to precisely coordinate the operation of the individual processing devices with one another to avoid faulty processing or time losses. Also in the case of individual processing devices or processing devices used outside of a processing line, in view of the high demands on the product throughput and the complexity of the processing devices themselves, settings of individual parameters of the processing device, for instance a cutting speed and a cutting force of a slicing device, may need to be precisely coordinated with one another and/or changed during the operation to be able to achieve optimal processing results. The processing devices may therefore have respective control devices so that, for example, a slicing speed may be subsequently corrected at a control device of the slicing device if a poor synchronization with the packaging machine is detected.

However, the coordination or setting of processing devices and the control of a processing line or an individual processing device in such plants may be undesirably time-consuming since the associated control device must always be actuated to adjust a setting of a processing device. However, an adjustment of a setting of the slicing device of a processing line may, for example, require a corresponding adjustment at the packaging machine so that a switch between the different control devices must be made. Furthermore, due to a control of the processing device at associated control devices, an operator of the processing line, for example, cannot immediately check whether a setting change at the slicing device causes an effect on the packaging machine. Therefore, the precise setting of the processing line, in particular to rectify a detected processing error, may take a relatively long time.

Furthermore, the adjustment of the settings of such processing devices must be carried out in a production hall that is usually cooled down to low temperatures so that the control of a processing device and/or a processing line often takes place under unpleasant working conditions. In addition, in situations where a user of the plant cannot rectify a possible processing error himself and requires the help of external experts, these experts must travel to the site to be able to carry out settings at the processing devices, which may involve a considerable time and cost effort.

It is therefore an object of the invention to provide a plant for processing food products having at least one processing device, which plant offers a simplified control of the at least one processing device and a possibility for a flexible service for the troubleshooting or adjustment of the at least one processing device by external experts or service providers.

This object is satisfied by the embodiments described herein.

The plant comprises a remote control device that may be positioned spatially separately from the at least one processing device, wherein the remote control device positioned spatially separately from the at least one processing device is configured to change a setting of the at least one processing device in response to a user input.

The remote control device may thus in particular be configured to change a setting of the at least one processing device in response to a user input if the remote control device is actually positioned spatially separately from the at least one processing device. The remote control device consequently enables a remote control of the at least one processing device so that, in the plant described herein, it is not necessary to be in the immediate vicinity of the at least one processing device in order to carry out an adjustment of the setting at the at least one processing device.

As will be explained in more detail below, in some embodiments, the plant may in particular comprise a processing line having
at least one slicing device having a product feed and at least one blade arranged in a cutting plane, wherein the product feed is configured to guide food products on one track or multiple tracks into the cutting plane, and wherein the blade is configured to cut off slices from the food products guided into the cutting plane in order to form portions, wherein a portion comprises one or more of the cut-off slices;
a packaging machine, in particular a deep-draw packaging machine, that is configured to provide respective packaging spaces for the portions and to package portions brought onto the packaging spaces; and
a transport device that is configured to transport the portions from the slicing device to the packaging machine and to bring said portions to the packaging spaces,
and the remote control device, which is positioned separately from the processing device, may in such embodiments be configured to change a setting of at least one processing device of the processing line in response to the user input.

In such embodiments, the remote control device may thus enable a remote control of at least one processing device of processing devices connected to one another or connected after one another in a processing line, wherein the remote control device may, however, in particular be configured to control processing lines of such plants as a whole and to make changes to settings of a plurality of processing devices and/or all the processing devices of the processing line. This is also explained in more detail below.

However, in some embodiments, the plant may also comprise only one processing device and may thus ultimately be formed by the one processing device (and the remote control device). For example, the plant may therefore, for instance, also be a slicing device that is operated independently of a processing line and that may be controlled by the remote control device. Furthermore, it may, for example, also be provided that a plant comprising a single processing device is integrated into a processing line, wherein only the one processing device may, however, be controllable via the remote control device of the plant, while a conventional control may be provided for the further processing devices of the processing line. For example, it is conceivable that a remote-controllable slicing device is integrated into a processing line whose further processing devices, for instance, come from other manufacturers and therefore may possibly not enable a remote control.

Since the remote control device may be positioned spatially separately from the at least one processing device and in particular from a processing line, the remote control device may in particular be positionable in a different room than the at least one processing device to be able to make settings at the at least one processing device from this room. For example, it may be provided that the at least one processing device is arranged in a production hall, whereas the remote control device may, for example, be arranged in a central control room, which may also be called a control station, to be able to control the at least one processing device and/or the processing line from there. In particular, the remote control device may be arranged in a room that does not need to be cooled down to the cold temperatures required for processing food products so that a more pleasant working environment may be created for controlling the at least one processing device. The room from which the remote control of the at least one processing device takes place may furthermore, for example, be arranged such that the at least one processing device and/or a processing line may be observed from there, for example through a window, wherein monitoring devices arranged in the environment of the plant or the at least one processing device may, however, generally also be used to observe the at least one processing device, as explained in more detail below.

For example, it may be provided that the remote control device is arranged in a control room associated with a respective production hall to be able to control a processing device or processing line arranged in the production hall. Furthermore, in particular a plurality of remote control units of the remote control device, for example a plurality of computers, may be arranged in the control room that are configured to control at least one respective processing device or at least one respective processing line in the production hall so that the processing devices or processing lines arranged in the production hall may be controlled from a common location-the central control room. Furthermore, it may, however, also be provided that the remote control device has a remote control unit, for example a computer, that is configured to change settings of different processing devices that are not connected to one another in a processing line, and in particular of processing devices of different processing lines, so that, for example, a plurality of processing lines, which are arranged in a common production hall, may be controllable by the remote control unit.

In principle, such a control of different processing devices and/or processing lines from a central location may make it possible that the respective persons responsible for a specific processing device or processing line may operate from a common room, which may in particular enable an exchange between the persons and a bundling of the expertise with respect to the control of such complex processing devices or processing lines. In particular, an improvement in the control of processing devices or processing lines in a production hall as a whole may hereby be achieved in that, for example, problems that have already been solved at other processing devices or processing lines may be solved promptly when they occur at another processing device or another processing line through a cooperation of the respective responsible person. Furthermore, substitution arrangements and generally a division of work between different persons entrusted with the control of processing devices and/or processing lines are possible in a simple and flexible manner.

Furthermore, it may be provided that the remote control device is configured to change settings of all the processing devices arranged in an entire factory and/or of all the processing lines arranged in an entire factory or their processing devices. For example, a factory in which food products are processed may comprise a plurality of production halls, wherein one or more processing lines may be arranged in each of the production halls and the remote control device may be configured to change settings at processing lines arranged in one or more different production halls by remote control. Such a control of processing lines arranged in different production halls from a central location may also enable the explained bundling of expertise and a simplified control of the processing lines.

In addition, the remote control device or a remote control unit of the remote control device may possibly also be positioned locally separately from the processing device or processing line to be controlled and in particular not within a factory complex in which the at least one processing device to be controlled is arranged. Such an arrangement of the remote control device may in particular enable a control of the at least one processing device, and in particular of a processing line, by an external service provider without the external service provider having to travel directly to the at least one processing device, and actuate a control device arranged there, in that the remote control device may be arranged locally separately from the at least one processing device at the external service provider. For example, a client or purchaser of a processing device and/or a processing line may thereby easily request a temporary control or a fine adjustment of settings from a manufacturer of the processing device and/or the processing line or from another service provider in order to be able to draw on the expertise of the manufacturer or service provider and to achieve an optimum setting of the at least one processing device and/or the processing line before the control may be taken over again by the owner of the at least one processing device and/or the processing line itself.

In particular, such a transfer of the control to an external service provider may be provided for a so-called running in of the at least one processing device or a processing line after its installation so that the external service provider or manufacturer of the plant may in particular first coordinate processing devices of a processing line with one another, whereupon the owner may start processing the food and take over the control. In addition, for example in the event of problems occurring during the processing, an external service provider may be enabled to check and adjust the settings of the at least one processing device so that expertise that may not be available on site may be used for problem solving. Furthermore, for example also in the event of absence due to illness, a service by an external service provider may be temporarily used to control the at least one processing device to be able to bridge such a period. Since the remote control device may in particular also be configured to control different processing devices and/or processing lines, possibly also processing devices and/or processing lines of different owners or customers of a manufacturer, the expertise available at the service provider with regard to the control of such processing devices and/or processing lines may furthermore be increased to be able to carry out the setting of the processing devices and/or processing lines more quickly, efficiently and reliably.

In summary, such a remote control device thus enables a more convenient and more flexible control of the at least one processing device, and in particular of processing lines having a plurality of processing devices, in that, for example, the settings of individual processing devices at control devices arranged directly at the processing devices do not have to be adjusted and a switch between different control devices does not have to be made to be able to achieve a mutual coordination of the individual processing devices. Furthermore, the changing of settings of the at least one processing device does not have to be carried out directly in a production hall, in which the at least one processing device is arranged and which is usually cooled down to cold temperatures, so that in particular possibly lengthy fine-tuning of processing devices to one another or fine-adjusting of individual processing devices may be carried out conveniently from a separate room and in particular from a central control room.

As already mentioned, the remote control device may in particular have different remote control units that are configured to adjust settings of the at least one processing device. For example, a remote control unit of the remote control device may therefore be arranged in a central control room and enable a control of processing devices arranged in an associated production hall, whereas another remote control unit may be arranged in a central control room of a factory complex, from which settings of all the processing device and/or processing lines arranged in the factory may be adjusted. Alternatively or additionally, the remote control device may furthermore have a remote control unit, which is positioned spatially separately from the at least one processing device, to enable a control by an external service provider.

In principle, the remote control device, in particular as a remote control unit, may, for example, comprise a computer having a CPU (Central Processing Unit) and/or a microcontroller and a connected monitor, wherein the user input may, for example, be entered via a keyboard and/or a mouse on the computer. Alternatively, a touchscreen operating device may, for example, also be provided. The remote control device may in particular comprise a plurality of such remote control units so that respective tasks of the remote control device may be carried out at or by different remote control units. The components or remote control units of the remote control device may furthermore be arranged in a common room or the remote control device may be distributed across different rooms. As already explained, it may, for example, be provided that a remote control unit of the remote control device is arranged in a central control room for controlling processing lines in a production hall, a further remote control unit is arranged in a central control room for controlling processing lines arranged in a common factory and/or a further remote control unit is arranged locally separately from the processing line or in a factory, in which the processing line is arranged, at an external service provider.

Further embodiments can be seen from the dependent claims, the description, and the drawings.

In some embodiments, the at least one processing device may be positioned in a first room, in particular a production hall, and the remote control device may be positionable in a second room that is different from the first room, in particular a control room, wherein the remote control device positioned in the second room may be configured to change the setting of the at least one processing device positioned in the first room in response to the user input.

As already explained, the remote control device may thus be configured to control the at least one processing device and/or a processing line from a room other than the room in which the at least one processing device is arranged. In this regard, the control in particular does not have to take place from a cold production hall, but may be conveniently performed at a central control station or a central control room.

In some embodiments, the at least one processing device may be configured as a slicing device having a product feed and at least one blade arranged in a cutting plane, wherein the product feed may be configured to guide food products on one track or multiple tracks into the cutting plane, and wherein the blade may be configured to cut off slices from the food products guided into the cutting plane in order to form portions, wherein a portion may comprise one or more of the cut-off slices.

Furthermore, in some embodiments, the at least one processing device may be configured as a packaging machine, in particular a deep-draw packaging machine, that is configured to provide respective packaging spaces for portions of food products and to package portions brought onto the packaging spaces.

In some embodiments, the at least one processing device may be configured as a transport device that is configured to transport portions from a slicing device to a packaging machine and to bring said portions to packaging spaces provided by the packaging machine.

In some embodiments, the at least one processing device may also be configured as a pressing device for pressing and/or shaping food products, in particular food products to be sliced, meat products and/or bacon. Such a pressing device is, for example, known from EP 10 3 760 047 A1 whose contents are included in the present disclosure with respect to the general design of such a pressing device. A further pressing device is described in the German patent with the number 10 2021 126 436 which is still to be published and whose contents are likewise included in the present disclosure with respect to the basic configuration of a pressing device for pressing and/or shaping food products.

Furthermore, in some embodiments, the at least one processing device may be configured as a device for providing web-like interleaved sheet material at a cutting region of a slicing device, having an unrolling device for removing a material web from a material web roll and an ejection device for a dynamic, in particular cyclical, ejection of the material web into the cutting region. Such a device is generally known to the skilled person and is, for example, described in DE 10 2019 106 369 A1 whose contents are included in the present disclosure with respect to the design of such a device.

In addition, in some embodiments, the at least one processing device may be configured as a cheese divider that is configured to divide a bar-shaped cheese product into a plurality of partial products. Such a cheese divider is described, for example, in DE 10 2019 108 452 A1 whose contents are likewise included in the present disclosure with respect to the basic design of a cheese divider.

In some embodiments, the at least one processing device may be configured as a device for providing a portion support at a transport device for transporting portions of food products to a packaging machine, which has a store in which a stack of a plurality of portion supports may be stored, and a removal device that is configured to remove a respective upper portion support from the store and to provide said respective upper portion support at the transport device such that a portion may be placed on the provided portion support during the transport by the transport device. Such devices are also generally known the skilled person and are, for instance, described in the not yet published European patent application 22 155 188.0 whose contents are likewise included in the present disclosure.

In particular, the remote control device may thus be configured to change a setting of at least one of the aforementioned processing devices in response to a user input. As already explained, in some embodiments, the plant may comprise a single processing device so that, in some embodiments, the plant may in particular be configured as one of the aforementioned processing devices and may furthermore comprise the remote control device, but no further processing devices. However, it is also possible that the plant comprises a plurality of processing devices, in particular a plurality of the aforementioned processing devices, and that the remote control device is configured to control one or more of the plurality of processing devices of the plant. A plant comprising a plurality of processing devices may further in particular comprise a processing line in which the plurality of processing devices, in particular a selection of the aforementioned processing devices, may be connected after one another.

In some embodiments, the remote control device and the at least one processing device may be connected to one another via a network. Such a network may in particular enable the necessary signal exchange between the remote control device and the at least one processing device in that current settings of the processing device may, for example, be communicated to the remote control device and may be displayed to an operator, for instance at a display device of the remote control device, in order then to be able to adjust the setting of the processing device, if necessary, by transmitting a corresponding control command from the remote control device to the processing device. In particular, the remote control device may be connected to a processing line comprising a plurality of processing devices via a network.

In some embodiments, the plant may have a radio module and the control device may be configured to transmit a control command to change the setting via a wireless connection to the radio module. The remote control device may in particular be configured to transmit the control command to the radio module via a radio connection. For example, it may be provided that the remote control device is configured to communicate with the at least one processing device via a WLAN/WiFi connection to be able to adjust settings at the at least one processing device or at a plurality of processing devices by remote control. A control via such a radio connection may in particular also enable a control of the at least one processing device by a remote control device or remote control unit arranged locally separately from the at least one processing device, for example by a remote control device arranged at an external service provider.

In some embodiments, the at least one processing device may comprise the radio module. However, it is also possible that the at least one processing device may be connected to a radio module, which is external with respect to the at least one processing device, to be able to receive and implement a control command.

In some embodiments, the plant may have at least one monitoring apparatus that may be selectively arranged at the at least one processing device and/or a processing line of the plant and the control device may be configured to receive at least one monitoring signal from the monitoring apparatus arranged at the at least one processing device.

For example, provision may be made to provide one or more cameras that may be selectively arranged at the at least one processing device or a processing line, wherein monitoring signals generated by the cameras and in particular the image data generated by the cameras may be transmitted to the remote control device. The image data may then be displayed at a display device, for example a monitor, of the remote control device to enable an operator of the remote control device, who is spatially separate from the at least one processing device and/or the processing line, to check the operation of the at least one processing device and/or the processing line. This may enable the operator to detect possible processing errors and, if necessary, to intervene by adjusting settings of one or more processing devices. Furthermore, the monitoring apparatus may, for example, comprise sensors, such as temperature or pressure sensors, and measurement values determined by these sensors may be transmitted to the remote control device and may, for example, likewise be displayed at a display device so that the operator of the remote control device may check whether the measurement values correspond to respective desired values. Furthermore, a selective arrangement of microphones at the at least one processing device and/or the processing line may also be provided to be able to detect any incorrect settings based on noises, for example grinding noises.

In particular, the monitoring apparatus may thus make it possible to obtain impressions and insights in addition to typical operating data using monitoring methods to be able to detect states of the at least one processing device and/or consequences of an adjustment of settings without having to be directly present at the plant.

While it may generally be provided for processing devices of such plants to equip the processing devices with a certain sensor system, it may be provided in the embodiments mentioned that the monitoring apparatus may only be selectively arranged at the at least one processing device and/or the processing line. In this regard, the monitoring apparatus may be explicitly provided to enable a remote control of the at least one processing device by means of the remote control device without, however, generally having to be attached to the at least one processing device and/or being necessary for the operation of the at least one processing device. The attachment of the monitoring apparatus may therefore in particular not be necessary to enable an operation of the at least one processing device in the first place and, for example, to enable a control via processing device control units arranged directly at the at least one processing device. Rather, the monitoring apparatus may, for example, be formed by a monitoring set that is to be selectively arranged at the at least one processing device and that comprises one or more monitoring devices that may be selectively mountable at the at least one processing device or in its environment in order to enable or support a remote control.

For example, provision may in this respect be made that an owner of the at least one processing device and in particular of a processing line orders and/or rents such a monitoring set for a period in which a control of the at least one processing device or the processing line by an external service provider is desired, for example, for running in a processing line or during periods in which an external control is required due to absence due to illness or to rectify faults. By selectively arranging the monitoring apparatus at the at least one processing device and/or the processing line, the service provider may then be enabled to monitor the operation of the at least one processing device and/or the processing line without the service provider having to be in the environment of the plant. As soon as a conventional on-site control-or a remote control from a central control room on site-subsequently has to take place again, the monitoring apparatus or the aforementioned monitoring set may be removed again so that the monitoring apparatus only needs to be installed at times at which an external observation of the at least one processing device and/or the processing line is required. An owner of the at least one processing device and/or the processing line therefore does not necessarily have to purchase the monitoring apparatus, but the arrangement and/or provision for a certain time period may, for example, be provided as a service by an external service provider or the manufacturer of the plant.

However, it may generally also be provided that the monitoring apparatus remains permanently arranged at the at least one processing device, for example, to enable a remote control from a room from which a production hall, in which the at least one processing device is arranged, cannot be seen. Furthermore, an owner of a plurality of processing devices and/or a plurality of processing lines may, for example, purchase a single monitoring apparatus, possibly having a plurality of monitoring devices, in order to arrange it as required and selectively at different processing devices and/or processing lines in a respective factory or a respective production hall and to support a remote control of the respective processing device and/or processing line.

While the monitoring apparatus or respective monitoring devices of the monitoring apparatus may further be mountable directly at the at least one processing device, the monitoring apparatus may generally also comprise monitoring devices that may be able to be selectively arranged in the environment of the at least one processing device without there being a mechanical connection between the at least one processing device and the monitoring device. For example, the monitoring apparatus may comprise a camera that may be selectively set up in the environment of the at least one processing device, for example on a tripod, and that may be connected to the remote control device to be able to observe the entire processing device or an entire processing line in an overview-like manner, whereas it may, however, also be provided to arrange cameras or sensors directly at the at least one processing device to be able to inspect the at least one processing device in detail.

In particular, the monitoring apparatus may likewise be connectable to the remote control device via a network and/or a radio connection, in particular a WLAN/WiFi connection.

In some embodiments, the monitoring apparatus may comprise a camera, a microphone, an acceleration sensor, a temperature sensor and/or a pressure sensor. For example, cameras may be used to check the operation of the at least one processing device and/or a processing line as a whole. When checking a processing line, the monitoring apparatus may, for example, comprise a camera oriented to a slicing device, a camera oriented to a transport device and/or a camera oriented to a packaging machine of the processing line. Furthermore, it may, for example, be provided to arrange a temperature sensor at work stations of a packaging machine, such as a molding station or a sealing station of a deep-draw packaging machine, in order to check whether an appropriate temperature is reached for the processing of the respective packaging material.

In some embodiments, the remote control device may have a display device that is configured to display information transmitted by the monitoring signal.

For example, such a display device may be a monitor which is connected to a computer and at which image data, for instance transmitted by a camera, may be displayed so that an operator of the remote control device may evaluate the image data and may monitor the operation of the at least one processing device. Furthermore, data or measurement values of a pressure or temperature sensor may, for example, be displayed at such a display device.

In some embodiments, the remote control device may be configured to control the monitoring apparatus arranged at the plant.

For example, the remote control device may be configured to change an orientation of a camera included in the monitoring apparatus to be able to selectively inspect different regions of a processing line and/or of the at least one processing device and to be able to detect any processing errors or incorrect settings. Furthermore, the remote control device may be configured to selectively activate or deactivate individual monitoring devices of the monitoring apparatus or a reproduction of monitoring signals of individual monitoring devices, for example, to be able to temporarily access acoustic signals recorded by a microphone or to select image data of a specific camera for a display that is directed towards a region to be inspected or to a processing device to be checked.

In some embodiments, the monitoring apparatus may comprise at least one camera and the remote control device may comprise a display device, wherein the display device may be configured to display image data received from the camera. For example, the display device may be a monitor that is connected to a computer of the remote control device. However, the remote control device may also comprise a combined display and input device, in particular a touchscreen, for example of a tablet, on which the image data received from the camera may be displayed.

Furthermore, in some embodiments, the remote control device may be configured to control the camera, wherein the remote control may in particular be configured to change an orientation of the camera and/or a zoom factor of the camera. As already explained, by changing the orientation of the camera, for example, a specific processing device of a processing line and/or a specific region of the at least one processing device may be intentionally inspected, wherein changing a zoom factor may furthermore in particular make it possible to intentionally inspect a detail of the at least one processing device. For example, the remote control device for controlling the camera may have a joystick as a separate control unit or the control of the camera may take place at a computer or another remote control unit via which the setting of the at least one processing device may be changed.

Furthermore, in some embodiments, the remote control device may be configured to automatically select a camera from a selection of a plurality of cameras of the monitoring apparatus and to display its image data on the display device. For example, the remote control device may be configured to use AI (artificial intelligence) that selects image data generated by a camera for the display if a movement or activity is detected in the image data. Furthermore, the AI may also be configured to automatically select a camera oriented to a processing device of a processing line for the display if an incorrect setting at this processing device is to be assumed based on the image data analyzed by the AI in order to inform an operator that the corresponding processing device must be checked. It may generally also be provided that the remote control device is configured to execute an AI for controlling the at least one processing device and/or a processing line so that, for example, a fully AI-guided plant control may be provided in a basic operation and an operator of the at least one processing device and/or the processing line only has to monitor the operation to be able to intervene in the event of incorrect settings by the AI. In particular, data on settings and processing results of one or more processing devices or processing lines may be used to optimize or train the AI.

In some embodiments, the plant may have at least one coupling device for coupling the monitoring apparatus. In particular, such a coupling device may be provided for mechanically coupling monitoring devices of the monitoring apparatus to the at least one processing device and/or a processing line so that the monitoring apparatus may so-to-say be selectively docked to the at least one processing device and/or the processing line if a remote monitoring of the plant operation is desired. For example, the coupling device may comprise plug-in closures and/or rotatable closures to be able to couple individual monitoring devices of the monitoring apparatus to the at least one processing device, and the coupling device may in particular have a plurality of coupling elements to be able to selectively arrange a plurality of monitoring devices of the monitoring apparatus, for example a plurality of cameras or a plurality of sensors, at the at least one processing device. However, it is not absolutely necessary for all the monitoring devices of the monitoring apparatus to be coupled to the plant via the coupling device and/or to be directly mechanically connected to the at least one processing device; rather, in embodiments with a coupling device, the monitoring apparatus may also comprise one or more monitoring devices that are merely arranged in the environment of the at least one processing device.

In some embodiments, the coupling device may furthermore have an interface for coupling the monitoring apparatus to the remote control device.

For example, the coupling device may have a network connection with the remote control device and/or a radio module for coupling with the remote control device so that, on a selective use of the monitoring apparatus and a coupling of the monitoring apparatus to the coupling device, the remote control device may be directly connected to the monitoring apparatus and may access monitoring signals transmitted by the monitoring apparatus and/or may control the monitoring apparatus. In this regard, the coupling device having the interface at the plant may so-to-say be provided for a selective connection of the monitoring apparatus so that, for example, a mobile monitoring set may be connected to the plant as required and an external monitoring of the at least one processing device or a processing line may be directly enabled by connecting the monitoring set. The remote control device may furthermore be configured to recognize when a respective monitoring device or the monitoring apparatus has been arranged at the coupling device in order to then access the monitoring apparatus and monitoring signals transmitted by the monitoring apparatus.

In some embodiments, the remote control device may be configured to write information transmitted by the monitoring apparatus and/or settings of the monitoring apparatus to a memory.

The remote control device may thus be configured to document information or settings transmitted by the monitoring apparatus in the memory in order, for instance, be able to subsequently determine the reason for errors in the operation of the at least one processing device. Furthermore, on a subsequent use of the monitoring apparatus, it is possible to directly access previously made settings of the monitoring apparatus, for example, to be able to correctly orient a camera to a respective processing device to be checked and/or to specific region of the at least one processing device without having to manually adjust the desired orientation on each new check of the processing device.

In some embodiments, the monitoring apparatus and/or the at least one processing device may have a flagging device that is configured to flag an active monitoring device of the monitoring apparatus and/or the at least one processing device in the event of a monitoring by the monitoring apparatus.

For example, such a flagging device may have at least one indicator light, which is arranged at the monitoring devices and/or at the at least one processing device, and the flagging device may be configured to activate the indicator light when the monitoring device is active or a monitoring of the at least one processing device takes place. Persons present in the environment of the at least one processing device may thus be alerted to the monitoring by such a light signal in order, for example, to prevent a person from being in the field of view of a camera monitoring the at least one processing device and thereby interfering with the monitoring.

In some embodiments, the remote control device may be connectable to a monitoring device, which is positioned in the environment of the at least one processing device but is not arranged directly at the at least one processing device, in particular a monitoring camera for monitoring a production hall, and may be configured to receive and/or to display a further monitoring signal from the monitoring device, in particular image data from the monitoring camera.

The remote control device may thus also be configured to make use of monitoring devices that are not arranged directly at the plant or are explicitly provided for monitoring the at least one processing device and/or a processing line, but that serve to monitor an environment of the plant. For example, monitoring cameras may be installed in a production hall to ensure the safety of persons working in the production hall and to be able to intervene as quickly as possible in the event of an incident. However, such monitoring cameras, which may, for example, be installed as 360° ceiling cameras, may also make it possible to obtain an overview of the operation of a processing device or processing line arranged in the production hall so that image data provided by such monitoring cameras may also be used to monitor the at least one processing device or a processing line. As an alternative to a monitoring camera, it may, for example, also be provided to transmit data provided by a thermometer for measuring the temperature in a production hall to the remote control device to be able to adapt the at least one processing device to a possibly changing hall temperature. In some embodiments, such an adaptation in dependence on the hall temperature may also take place automatically, in particular by means of the remote control device, without a user input being necessary.

In some embodiments, the remote control device may be configured to determine the connected monitoring device. For example, the remote control device may be configured to control the orientation and/or a zoom factor of a monitoring camera in a production hall in which the at least one processing device is arranged when the monitoring device is connected to the remote control device. As already explained, such monitoring devices may in particular serve to obtain an overview of the operation of the at least one processing device or a processing line, wherein individual regions of a processing line or a processing device may, however, also be inspected precisely in a top view by zooming in at a ceiling camera, for example. Furthermore, the remote control device may be configured to write settings of the monitoring device and/or information transmitted by the monitoring device to the aforementioned memory so that such settings or information may also be accessed during subsequent controls of the at least one processing device.

Furthermore, in some embodiments, a memory may be provided into which settings of the at least one processing device and/or a processing line may be written. In particular, in such embodiments, the remote control device may be configured to write settings of the at least one processing device into the memory.

Since the settings of the at least one processing device may be stored in such a memory, previous settings of the at least one processing device and in particular settings of all the processing devices of a processing line may be accessed at any time and the processing line may possibly overall be set in accordance with these settings. For example, respective optimal settings of the at least one processing device or a plurality of processing devices may therefore be stored in dependence on a temperature in a production hall and the at least one processing device or the plurality of processing devices may always be optimally set in dependence on a measured temperature of the production hall.

Furthermore, such a documentation of settings may, however, also make it possible to use these settings to control a further processing device or processing line, for example, by adopting settings of a similar processing line having identical processing devices when setting a new processing line in order to start the running in of the processing line based on these settings, in particular also considering further empirical values, for example empirical values with specific products or packaging films. There may indeed be minor differences between the two processing lines despite their similarity, for example slightly different distances at belt transitions between transport belts of the transport device, or the processing lines may, for example, be operated at different hall temperatures so that the adopted settings for the further processing line still need to be optimized, but the running in may thus be started based on at least approximately correct settings. In particular, such a running in of new processing lines may therefore be simplified and accelerated by using a documentation of settings of further processing lines. However, in the case of such a procedure, it may also be a positive effect if the competence of the personnel may be bundled, at least temporarily, in that settings of the at least one processing device may take place via the remote control device and possibly from a central control room.

Furthermore, documenting the settings of the at least one processing device also makes it possible to subsequently analyze and, for example, retrace possible processing errors as to whether one and/or which processing device of a processing line was set incorrectly.

In some embodiments, the remote control device may be configured to receive information about a setting of at least one further processing device, in particular a further processing line. The remote control device may in particular be configured to read the information from the aforementioned memory.

For example, such a memory may be connected to the remote control device via a network and may in particular be realized on a cloud or network basis so that an exchange of settings of different processing devices and/or processing lines may take place via the cloud and an operator of a respective processing device or processing line may access information that relates to the settings of other, but in particular similar, processing devices or processing lines. Due to such a cloud-based solution, a bundling of competence with respect to the control of processing devices or processing lines, which the operators of respective processing devices or processing lines may access, may thus so-to-say take place. In particular, such a cloud-based or network-based memory may be readable by an external service provider or manufacturer so that they may access the settings of numerous processing devices or processing lines and may consider them when setting a specific processing device or processing line for which an external control is requested.

Furthermore, in some embodiments, the remote control device may be configured to adjust the at least one processing device, in particular a processing line, in accordance with the received information. For example, the remote control device may read a set of settings of a further processing device or a further processing line from the memory and may directly set the processing device or processing line to be controlled in accordance with these settings. As already explained, this may in particular take place before the running in of a new processing line in that the settings of a similar processing line may so-to-say be copied. To enable such a copying of settings, an operator of the remote control device may, for example, select a respective processing line from a menu of the remote control device from which the settings are to be taken over. In such a menu, for example, all the processing lines of a production hall, a factory or possibly a plurality of factories of one or more clients of a manufacturer of the plant may be listed, in particular to enable a client-internal exchange of information, but possibly also an exchange of information between different clients of the manufacturer of the plant. In particular, it may also be provided that an external service provider and, for example, the manufacturer of the processing line itself may access settings of all the processing lines that may be controlled via the remote control device and in particular settings of processing lines of different clients to be able to offer each of the clients an optimal service with respect to the external control of the processing line. In the same way, however, a transfer of settings of an individual processing device,
for instance a transfer of settings of a slicing device to a further slicing device, may also be provided, for example.

A control of the at least one processing device by the remote control device may be able to be requested and/or enabled in some embodiments.

For example, it may be provided to request a remote control by an external service provider if required and/or to release the at least one processing device or a processing line for such an external remote control, whereas the external service provider cannot control the at least one processing device in a basic setting—without a request and/or release—but the control of the at least one processing device is reserved for the respective owner of the at least one processing device. Furthermore, such a request and/or release may also so-to-say be internally provided in that a control of the at least one processing device directly at a respective control device of the at least one processing device may generally still be possible and a switch to a remote control starting from a central control room or control station may only be made if necessary or in response to a corresponding request.

In some embodiments, the remote control unit may comprise a remote control unit that is positioned in a stationary manner and that is configured to change the setting in response to the user input. In particular, such a remote control unit arranged in a stationary manner may be a computer, possibly having a monitor for displaying information, that is arranged in a room which is separate from the processing line and by which the processing line may be controlled.

In some embodiments, the remote control device positioned in a stationary manner and the at least one processing device may be positioned in separate rooms, but within a common factory complex. Alternatively thereto, in some embodiments, the remote control unit positioned in a stationary manner may be positioned locally separately from the at least one processing device and outside a factory complex in which the at least one processing device is arranged.

For example, it may be provided that the remote control unit positioned in a stationary manner enables a remote control of the at least one processing device or a processing line from a central control room of a factory complex, wherein, alternatively thereto, a completely external remote control, in particular by an external service provider, may also be made possible. Furthermore, under certain circumstances, it may also be made possible to carry out a control of the processing line from the home office in that a remote control unit positioned in a stationary manner may be positioned at the residence of an employee responsible for controlling the at least one processing device or the processing line.

Furthermore, in some embodiments, the remote control device may comprise a first remote control unit positioned in a stationary manner and a second remote control unit positioned in a stationary manner that are configured to change the setting of the at least one processing device in response to the user input and in particular to change settings of all the processing devices of a processing line in response to respective user inputs, wherein the first remote control unit positioned in a stationary manner and the at least one processing device and/or the processing line are positioned in separate rooms, but within a common factory complex, and wherein the second remote control unit positioned in a stationary manner is positioned locally separately from the at least one processing device and/or the processing line and outside the factory complex. In such embodiments, both a centralized remote control within the factory complex and an external remote control with respect to the factory complex, in particular by an external service provider, may be made possible. In such embodiments, a control by the remote control unit arranged outside the factory complex may furthermore in particular be able to be requested and/or enabled so that an external service provider must be explicitly granted access to a respective processing device and/or processing line, whereas the control may be reserved for the owner of the processing device and/or the processing line in the absence of such a request and/or release.

In some embodiments, the remote control device may comprise a portable remote control unit that is configured to change the setting in response to the user input, wherein the portable remote control unit may have a display device for displaying information and an input device for entering the user input. In particular, the portable remote control unit may furthermore have a combined display and input device, preferably a touchscreen.

Such a portable remote control unit may in particular be configured as a tablet or a laptop and may in particular make it possible to flexibly control the at least one processing device and/or a processing line having a plurality of processing devices connected after one another from different locations. In particular, this may take place in that the portable remote control unit may be connectable to the at least one processing device via a network and/or a radio connection, in particular a WLAN/WiFi connection. Such a mobile remote control unit may in particular enable an operator to move along the plant in order to check the operation of the plant and to be able to make settings at any time even from, for example, remote processing devices of a processing line without having to move to a control device arranged directly at the respective processing device. For example, an operator of the portable remote control unit, said operator being positioned at the packaging machine, may therefore adjust settings of the slicing device to immediately check the extent to which these changes affect the operation of the packaging machine. Furthermore, a flexible remote control via a laptop, for example from the home office, may be made possible.

Also in this context, an efficient cooperation of an operator working on the plant in a mobile manner with external support may in particular be realizable if the external person can see the person working in a mobile manner at the at least one processing device, for which purpose the aforementioned monitoring apparatus and/or the external monitoring device may again be used.

In some embodiments, the plant may comprise at least one processing device control unit, which is arranged at the at least one processing device, for controlling the at least one processing device. Also in the plant described herein, conventional control devices may therefore furthermore be provided at the processing device or processing devices, for example, to be able to change settings of a slicing device directly at the slicing device. This may, for example, also enable a person positioned directly in the environment of the at least one processing device to intervene and to change settings in the event of a malfunction.

In some embodiments, the remote control device may be configured to transmit a control command to change a setting of the at least one processing device to the processing device control unit and the processing device control unit may be configured to implement the control command and/or to display information about the control command. For example, by displaying the control command at the processing device control unit, an operator may be informed at the at least one processing device that a setting of the at least one processing device should be changed, wherein the decision-making authority may, however, remain with the operator of the processing device control unit. Alternatively thereto, the remote control device may be directly configured to control the processing device control unit to implement the control command so that the remote control device may change settings of the at least one processing device via the associated processing device control units and may be connected to the processing device control units for this purpose.

Furthermore, in some embodiments, the remote control device may be configured to change a setting of the at least one processing device while bypassing the processing device control unit. In such embodiments, a direct control of the at least one processing device by the remote control device may thus be provided and a direct signal connection may exist between the remote control device and the at least one processing device.

In some embodiments, the plant may comprise a processing line having at least the following processing devices:
at least one slicing device having a product feed and at least one blade arranged in a cutting plane, wherein the product feed is configured to guide food products on one track or multiple tracks into the cutting plane, and wherein the blade is configured to cut off slices from the food products guided into the cutting plane in order to form portions, wherein a portion comprises one or more of the cut-off slices;
a packaging machine, in particular a deep-draw packaging machine, that is configured to provide respective packaging spaces for the portions and to package portions brought onto the packaging spaces; and
a transport device that is configured to transport the portions from the slicing device to the packaging machine and to bring said portions to the packaging spaces.

In such embodiments, the remote control device, which is positioned spatially separately from the processing device, may be configured to change a setting of at least one processing device of the processing line in response to the user input. In this regard, the remote control device may in particular be configured to control one or more processing devices of such a processing line.

In some embodiments, the remote control device, which is positioned spatially separately from the processing line, may be configured to change settings of at least two processing devices of the processing line. In particular, the remote control device may be configured to change settings of all the processing devices of the processing line in response to a corresponding user input. Therefore, in some embodiments, the remote control device may be configured to control the processing line.

In particular, settings of the processing devices and the coordination of settings of the processing devices with one another may thus be carried out conveniently at the remote control device and from a central location without having to actuate a control device associated with the respective processing device and to switch between such control devices, in particular control devices arranged directly at the individual processing devices, in order to change a setting of a respective processing device.

In some embodiments, the processing line may furthermore comprise devices connected upstream or downstream, such as a product cooling device, and/or further processing devices, such as a pressing device, and the remote control device may be configured to change settings of such devices. In particular, in some embodiments, the processing line may comprise one or more of the further processing devices already mentioned above, in particular a device for providing web-like interleaved sheet material at a cutting region of the slicing apparatus, a device for providing a portion support at the transport device, a pressing device and/or a cheese divider. The remote control device may be configured to change settings of one or more of these processing devices in response to respective user inputs.

A processing device configured as a packaging machine may in particular be configured as a deep-draw packaging machine and may have a material store in which a material web, in particular a film web and/or a paper web, is wound into a roll. The packaging machine may further have a removal device for removing the material web from the roll. Furthermore, a molding station may be provided to form depressions in the provided material web, into which depressions provided portions may be insertable. To be able to seal such depressions, the packaging machine may have a sealing station at which the depressions may be sealed by a fed upper material web and complete packages may thus be produced. The upper material web may also in particular be formed by a film web and/or a paper web. Furthermore, the packaging machine may be configured for a multi-track operation and/or a separating station may be provided at which the individual packages are separated from one another.

As an alternative to a deep-draw packaging machine, it is, however, also possible for the portions to be placed on a provided material web without depressions being formed in the material web beforehand. In this regard, the packaging spaces may represent defined positions on such a material web. Once again, the portions may, however, be sealed at a sealing station by a fed upper material web and packaging produced in this way may be separated. Furthermore, in some embodiments, the packaging machine may be configured to provide packaging bases as so-called trays into which the portions may be placed, wherein the packaging bases may subsequently in particular be sealed.

The invention further relates to a plant system comprising at least a first plant for processing food products, in particular meat products and/or cheese products, in particular a first plant according to any one of the above-explained embodiments, and at least a second plant for processing food products, in particular meat products and/or cheese products, in particular a second plant according to any one of the above-explained embodiments, wherein the first plant and the second plant comprise at least one respective processing device. Furthermore, the plant system comprises a remote control device that may be positioned spatially separately from the at least one processing device of the first plant and spatially separately from the at least one processing device of the second plant, wherein the remote control device, which is positioned spatially separately from the processing devices, is configured to change at least one setting of the at least one processing device of the first plant and at least one setting of the at least one processing device of the second plant in response to a respective user input.

In such a plant system, a remote control device is thus provided by means of which the processing devices of at least two different plants and in particular at least two different processing lines may be controlled. In this regard, the remote control device may, for example, be configured to control all the processing lines arranged in a respective production hall or in a factory so that the control of the processing lines may take place from a central control room or a central control station. In some embodiments, the processing device of the first plant and the processing line of the second plant may therefore be arranged spatially separately from one another and, for example, in different production halls and/or different factories, wherein it is, however, also possible for the two plants to be arranged in a common room, in particular in a common production hall.

As already explained in connection with the plant for processing foods, the plants of the plant system may in particular have a respective processing line having a plurality of processing devices. With such a configuration of the plants, the remote control device may therefore be configured to control the processing lines of the two plants.

Furthermore, in some embodiments, the remote control device may be configured to control a plurality of spatially and/or locally separate processing devices and/or processing lines so that, for example, processing lines in different factories and/or processing lines of different clients may be controlled as required by an external service provider via the remote control device.

Furthermore, the remote control device may in particular be the remote control device already described above in relation to one plant, wherein, however, the remote control device is in this case shared by both plants of the plant system so that settings at the processing devices and/or processing lines of both plants may be changed by means of a (single) remote control device or a (single) remote control unit, for example a computer.

In some embodiments, the processing devices of the plants may be configured, as already explained above, as a slicing device, a transport device, a packaging machine, a pressing device, a device for providing web-like interleaved sheet material at a cutting region of a slicing device, a cheese divider and/or a device for providing a portion support at a transport device. In particular, the processing devices of the two plants may be configured in the same way so that the first plant may, for instance, comprise a first slicing device and the second plant a second slicing device.

In some embodiments, the remote control device may be configured to communicate via a network with the at least one processing device of the first plant and the at least one processing device of the second plant. In particular, the remote control device may furthermore be connected to the first plant and the second plant via a radio connection, in particular a WLAN/WiFi connection, to be able to change settings of the processing devices of the plants via such a radio connection and to be able to control the processing lines.

In some embodiments, the first plant and the second plant may be positioned in a common production hall, in a common factory complex or locally separately from one another in different factory complexes. As already explained, the remote control device may thus in particular be configured to control processing lines or processing devices arranged in a common production hall, processing lines or processing devices arranged in a common factory complex or processing lines or processing devices arranged in different factory complexes, wherein the processing lines or processing devices arranged in different factory complexes may furthermore be associated with the same owner or different owners.

In some embodiments, the first plant and the second plant may have a respective local control device for controlling the at least one processing device, in particular for controlling a respective processing line, and the remote control device may be configured to transmit a control command to change the setting to the local control device of the first plant and/or the local control device of the second plant, wherein the respective control device may be configured to implement the control command and/or to display information about the control command.

The local control device may in particular be a processing device control unit already mentioned above, wherein it may, however, also be provided that the local control device is formed by a remote control device associated with a respective plant. Therefore, a remote control device arranged at an external service provider may, for example, be configured to transmit a control command to a remote control device or remote control unit arranged in a central control room of a client, wherein an operator of this local remote control device may then decide to implement the control command or to select a different setting. Such a display of control commands may, for example, also enable training by the external service provider of personnel to be trained at the client to control processing devices and/or a processing line. However, it may also be provided that the control device is configured to implement the received control command directly so that a control of the at least one processing device by the remote control device may take place via the local control device in some embodiments.

In some embodiments, the remote control device may further be configured to control the at least one processing device of the first plant and/or the at least one processing device of the second plant, in particular respective processing lines of the plants, while bypassing the respective local control device. Furthermore, in some embodiments, a control by the remote control device may be able to be requested and/or enabled. In such embodiments, a direct control of the processing devices and/or processing lines may therefore take place by the remote control device, wherein such an external control may, however, possibly be able to be enabled and/or requested so that the external control may not be provided in a basic setting and the control in the basic setting may be reserved for the owner of the at least one processing device or processing line.

In some embodiments, the remote control device may be configured to receive and/or to display a monitoring signal from a monitoring apparatus selectively arranged at the first plant and/or the second plant. In such embodiments, provision may thus be made to selectively arrange a monitoring apparatus at the first plant and/or the second plant, in particular at their processing devices or processing lines, and to transmit monitoring signals generated by the monitoring apparatus to the remote control device in order to enable an operator of the remote control device to monitor a state of the processing device to be controlled.

As already explained, it may, for example, be provided that a monitoring apparatus that may be selectively arranged at the processing devices comprises a camera, wherein the image data generated by the camera may be transmitted to the remote control device so that an operator of the remote control device may monitor the operation of the at least one processing device and/or may intentionally inspect different processing devices of a processing line. Furthermore, for example, microphones, temperature sensors and/or pressure sensors may be able to be selectively arranged at the processing lines to enable a monitoring.

In some embodiments, the remote control device may be configured to control the monitoring apparatus arranged at the processing line. In particular, the remote control device may be configured to control a camera selectively arranged at the processing line and, for example, to change its orientation and/or its zoom factor. This may in particular enable an operator of the remote control device to intentionally view specific regions of a processing device or processing line to be able to detect any incorrect settings of processing devices.

In some embodiments, the remote control device may be connectable to a monitoring device, which is positioned in the environment of the first plant and/or the second plant, and may be configured to receive and/or to display a further monitoring signal from the monitoring device, in particular image data from a monitoring camera for monitoring a production hall. Such further monitoring devices, which are thus not located directly at the processing lines but merely in the environment of the plants, may therefore also be used to monitor the operation of the plants from the location at which the remote control device is installed. For example, the monitoring device may be a monitoring camera that is arranged at the ceiling of a production hall and that is provided to monitor the operation in the production hall as a whole.

Furthermore, in some embodiments, the remote control device may be configured to control the connected monitoring device. In particular, it may in this respect be provided that the remote control device is configured to adjust an orientation and/or a zoom factor of a connected monitoring camera, for example, to be able to intentionally zoom in on a specific region of the at least one processing device or a processing line from a top view.

In some embodiments, the remote control device may be configured to receive information about settings of the at least one processing device and/or a processing line of the first plant and to set the at least one processing device and/or a processing line of the second plant in accordance with the received information. In particular, as already explained, this may be provided if a processing line of the second plant corresponds to the kind of processing line of the first plant and in particular has identical processing devices, wherein the settings of the processing line of the first plant may in particular be transmitted before a running in of the processing line of the second plant so that the running in of the processing line of the second plant may already be started with approximately optimal settings. For this purpose, provision may, for example, be made that the remote control device accesses a cloud-based or network-based memory or the settings of all the processing lines in a production hall and/or in a factory complex may be stored in a central memory to which the remote control device is connected to be able to select the respective settings, for example by selecting a specific processing line, and to transfer them to a further processing line. In the same way, it may, however, be provided to transfer the settings of a single processing device, for instance of a slicing device used outside a processing line, and to transfer them to a similar processing device.

In some embodiments, the remote control device may be configured to write information about settings of the at least one processing device of the first plant and/or of the at least one processing device of the second plant into a memory. In this regard, settings made at the respective processing devices and/or processing lines may also be considered when setting a further processing device or processing line and a documentation of settings made may take place to be able to subsequently analyze possible errors in the operation of the plant.

In some embodiments, the first plant and the second plant may comprise a respective processing line having at least the following processing devices:
at least one slicing device having a product feed and at least one blade arranged in a cutting plane, wherein the product feed is configured to guide food products on one track or multiple tracks into the cutting plane, and wherein the blade is configured to cut off slices from the food products guided into the cutting plane in order to form portions, wherein a portion comprises one or more of the cut-off slices;
a packaging machine, in particular a deep-draw packaging machine, that is configured to provide respective packaging spaces for the portions and to package portions brought onto the packaging spaces; and
a transport device that is configured to transport the portions from the slicing device to the packaging machine and to bring said portions to the packaging spaces.

In such embodiments, the remote control device may be positionable spatially separately from the processing line of the first plant and spatially separately from the processing line of the second plant and the remote control device positioned spatially separately from the processing lines may be configured to change at least one setting of the at least one of the processing devices of the processing line of the first plant and to change at least one setting of at least one of the processing devices of the processing line of the second plant in response to a respective user input.

In some embodiments, the remote control device, which is positioned spatially separately from the processing lines, may be configured to change settings of at least two processing devices of the processing lines. In particular, the remote control device may be configured to change settings of all the processing devices of the processing lines and to control the processing lines in this regard.

The invention further relates to a method for controlling a plant for processing food products, in particular meat products and/or cheese products, in particular a method for controlling a plant according to any one of the embodiments described herein. The plant comprises at least one processing device.

In this method, at least one monitoring signal of a monitoring apparatus selectively arranged at the at least one processing device and/or at least one monitoring signal of a monitoring device arranged in the environment of the at least one processing device, in particular a monitoring camera for monitoring a production hall, is transmitted to a remote control device positioned spatially separately from the at least one processing device and at least one setting of the at least one processing device is changed by a user input at the remote control device, which is positioned spatially separately from the processing device, considering the monitoring signal.

In this method, it is thus first provided to control at least one processing device, but in particular a processing line having a plurality of processing devices, of a plant of the mentioned kind by a remote control device so that, for instance, a control device arranged directly at the at least one processing device or individual control devices of processing devices of a processing line do not have to be operated to be able to change settings at the at least one processing device and/or the processing line. However, to be able to achieve the most precise control possible here while considering current conditions, it is further provided to connect the remote control device to a monitoring apparatus selectively arranged at the at least one processing device, for example a camera that may be selectively arranged at the at least one processing device, or to make use of monitoring devices that are anyway present in the environment of the at least one processing device and to connect them to the remote control device.

As already explained, it may, for example, be provided that the at least one processing device and/or a processing line may be selectively equipped with a monitoring set to enable an operator of the remote control device to check the operation. Therefore, the monitoring set may in particular be arranged at the at least one processing device and/or the processing line at times at which a remote control is desired or required in order, for instance, to enable a control by an external service provider. However, at times at which a conventional control is sufficient or the control takes place from a point or a room from which the at least one processing device and/or the processing line may be kept in view anyway, the monitoring set may, however, selectively be removed again. This may also make it possible to rent such a monitoring set only for times at which an external control or external help with the control is required.

In some embodiments, settings of a plurality of processing devices, in particular all the processing devices of a processing line, may be changed by a corresponding user input at the remote control device positioned spatially separately from the at least one processing device and/or the processing line. In particular, a processing line comprising a plurality of processing devices may thus be controlled by the remote control device.

In some embodiments, the monitoring apparatus may be arranged at the at least one processing device for the preparation of the remote control, wherein the monitoring apparatus may in particular be removed from the at least one processing device again after the remote control has ended. In this regard, the monitoring apparatus may be selectively arranged at the at least one processing device and may, for example, be attached to a coupling device provided for this purpose if a remote control is desired in order, however, to then remove the monitoring apparatus again and to return to a conventional operation and a conventional control of the at least one processing device.

In some embodiments, the monitoring apparatus may be controlled by the remote control device that is positioned spatially separately from the at least one processing device. As already explained, it may in particular be provided to change an orientation and/or a zoom factor of a camera included by the monitoring apparatus by means of the remote control device, for example by means of a joystick, to be able to intentionally inspect specific regions of the at least one processing device and/or a processing line at the remote control device.

In some embodiments, an active monitoring device of the monitoring apparatus and/or the at least one processing device may be flagged in the event of a monitoring by the monitoring apparatus. For example, a light signal may be displayed at an active monitoring device and/or at a monitored processing device in order to draw the attention of persons in the environment of the at least one processing device to the monitoring. This may, for example, prevent persons from being in the field of view of a camera included by the monitoring apparatus while the camera is used to monitor the at least one processing device.

Further, in some embodiments, the monitoring device arranged in the environment of the at least one processing device may be controlled by the remote control device. In this regard, it may, for example, also be provided to control a monitoring camera that is provided for monitoring a production hall by means of the remote control device and, for example, to use a ceiling camera to zoom in on a specific region of a processing line and to inspect this region from a top view.

In some embodiments, the plant may comprise a processing line having at least the following processing devices:
at least one slicing device having a product feed and at least one blade arranged in a cutting plane, wherein the product feed is configured to guide food products on one track or multiple tracks into the cutting plane, and wherein the blade is configured to cut off slices from the food products guided into the cutting plane in order to form portions, wherein a portion comprises one or more of the cut-off slices;
a packaging machine, in particular a deep-draw packaging machine, that is configured to provide respective packaging spaces for the portions and to package portions brought onto the packaging spaces; and
a transport device that is configured to transport portions from the slicing device to the packaging machine and to bring said portions to the packaging spaces.

In such embodiments, at least one setting of at least one processing device of the processing line may be changed by the user input at the remote control device, which is positioned spatially separately from the processing line, considering the monitoring signal. In particular, the remote control device may thus be configured to control a processing line having the aforementioned processing devices.

In some embodiments, the remote control device, which is positioned spatially separately from the processing lines, may be configured to change settings of at least two processing devices of the processing lines. In particular, the remote control device may be configured to change settings of all the processing devices of the processing lines and to control the processing lines in this regard.

In some embodiments, information about settings of at least one processing device of a further plant may be received or retrieved at the remote control device that is positioned spatially separately from the at least one processing device and the at least one setting may be changed in accordance with the information. In particular, settings of a processing line of another plant may in this respect be copied and a processing line of the plant as a whole may be set according to the settings of the other processing line. As already explained, such a copying of settings of another processing line may in particular take place before a running in of the processing line to be able to start the running in with approximately optimal settings.

In some embodiments, the at least one setting may be optimized starting from the setting made in accordance with the information. In particular, the settings of a processing line as a whole may be optimized starting from the settings made in accordance with the information. For example, it may be provided for this purpose to first set a processing line of a plant in accordance with the already optimized settings of a similar or identical processing line before a running in in order, starting from these settings, to then run in the specific processing line and to optimize its settings in order, as a result, to also be able to consider small differences between the processing lines, for example. However, such a procedure may also be used for individual processing devices and/or processing devices operated outside a processing line or for plants that only comprise a single processing device.

The invention will be explained in the following purely by way of example with reference to embodiment examples and to the drawings.

### BRIEF DESCRIPTION OF THE DRAWINGS

There are shown:

FIG. 1 a schematic representation of a plant for processing food products having a processing line which comprises a plurality of processing devices and for whose control a remote control device is provided;

FIGS. 2A and 2B respective further schematic representations of the plant, wherein furthermore a monitoring apparatus selectively arranged at the processing line and having a plurality of monitoring devices is shown, said monitoring devices transmitting respective monitoring signals to the remote control device; and

FIG. 3 a schematic representation of a plant system having a plurality of plants for processing food products, the processing lines of said plants being controllable by a remote control device having a plurality of stationary remote control units.

### DETAILED DESCRIPTION

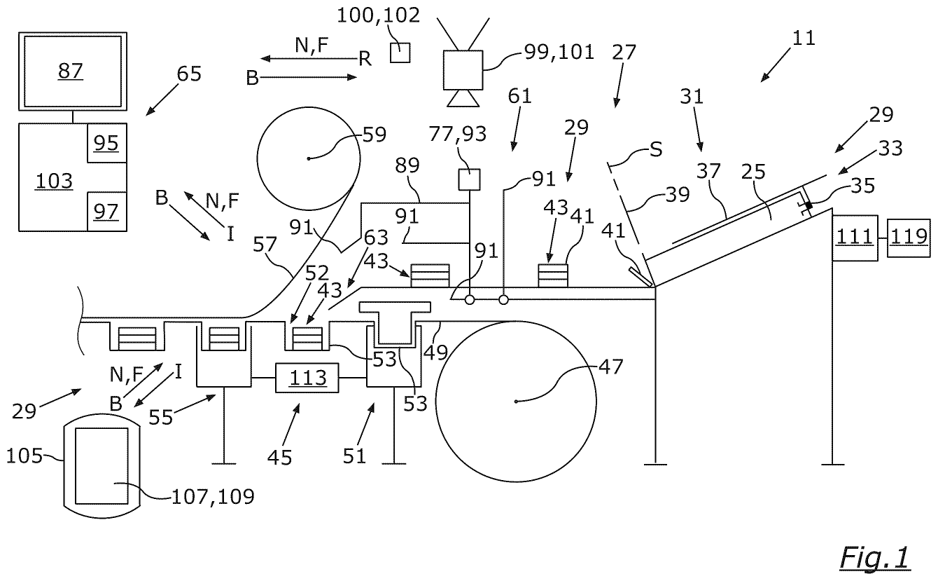

FIG. 1 shows a plant 11 for processing food products 25, wherein the food products 25 may in particular be cheese products and/or meat products. The plant 11 comprises a processing line 27 that has a plurality of processing devices 29 to produce, from bar-shaped food products 25, completely packaged portions 43 that comprise one or more slices 41 cut off from the food product 25.

To enable this processing, the processing line 27 first comprises a slicing device 31 that has a product feed 33 by means of which the food product 25 shown may be moved into a cutting plane S in which a revolving blade 39 is arranged. For this purpose, the product feed 33 in particular comprises a gripper 35 that is guided in a guide 37 and that holds the food product 25 at a rear product end and moves it into the cutting plane S. The blade 39, which may in particular be configured as a circular blade or a scythe-like blade, is configured to cut off slices 41 from the food product 25 moved into the cutting plane S, wherein portions 43 are formed from the cut-off slices 41 and comprise one or more, here by way of example three, slices 41.

As soon as a portion 43 has been completed and the provided number of slices 41 has been cut off from the food product 25, the portion 43 is taken over by a transport device 61 that transports the portions to a packaging machine 45. For this purpose, the transport device 61 may, for example, comprise one or more continuously revolving transport belts. To enable the portion 43 to be taken over by the transport device 61, the blade 39 may in particular be configured to make one or more empty cuts during which no slice 41 is cut off from the food product 25, for which purpose the blade 39 may, for example, be moved briefly out of the cutting plane S or the food product 25 may be withdrawn from the gripper 35.

The packaging machine 45 is by way of example configured as a deep-draw packaging machine and comprises a molding station 51 by means of which depressions 53 are formed in a material web 49 drawn off from a material web roll 47 in order to then provide the depressions 53 as packaging spaces 52 such that the portions 43 may be brought onto the packaging spaces 52 or into the depressions 53 by the transport device 61. To make this possible, the transport device 61 shown here has a feeder 63 that may in particular be a continuously revolving transport belt which faces the packaging machine 45 and from which the portions 43 may slide into associated depressions 53. However, it is known to the skilled person that transport devices of such plants 11 may also comprise, as an alternative or in addition to the feeder 63, a so-called picker robot that is configured to pick up portions 43 fed on a transport belt from the transport belt and to bring them to the packaging spaces 52.

After a portion 43 has been inserted into a respective depression 53, the depression 53 with the inserted portion 43 is guided by the packaging machine 45 to a sealing station 55, wherein the sealing station 55 is configured to seal the packaging depression 53 by means of an upper material web 57 drawn off from a roll 59 and fed to the sealing station 55. Furthermore, the packaging machine 45 may have a separating device, not shown, to separate the sealed depressions 53 and, as a result, to produce individual food packages in which a respective portion 43 is packaged. The packaging machine 45 may further be configured for a cyclical operation, wherein, after each cycle, a movement of the material web 49 may take place and the portions 43 may be brought onto the provided packaging spaces 52, in particular when the material web 49 is stationary or between consecutive movements of the material web 49.

The material web 49 and/or the upper material web 57 may in particular comprise a film and/or a paper, wherein a multi-layer design of the material web 49 and the upper material web 57 is also possible, in which design the individual layers may possibly be formed from different materials. Furthermore, the slicing device 31, the transport device 61 and/or the packaging machine 45 may be configured for a multi-track operation in that the product feed 33 of the slicing device 31 may, for example, be configured to feed two food products 25, three food products 25 or four food products 25 into the cutting plane S at the same time so that the blade 39 may simultaneously cut off slices 41 from a plurality of fed food products 25 and may form portions 43 from the cut-off slices 41. The portions 43 may then simultaneously be transported in a plurality of tracks to the packaging machine 45 and the packaging machine 45 may, for example, be configured to provide, in a respective cycle, a format of a plurality of packaging spaces 52, in particular a plurality of depressions 53, for the fed portions 43 that are to be brought onto the packaging spaces 52 during the cycle or before a subsequent movement of the material web 49. For example, a format may comprise nine packaging spaces 52 that are arranged in three rows and three columns and that may be filled in a single cycle of the packaging machine 45. In order to also be able to compensate for a higher portion rate of the slicing device 31 compared to a cycle rate of the packaging machine 45, the transport device 61 may have buffer paths, not shown, on which excess portions 43 may be temporarily stored in order, for example, during a loading pause, during which a subsequent product is loaded into the product feed 33 of the slicing device 31, to be brought onto packaging spaces 52 provided in the meantime by the packaging machine 45.

As an alternative to a deep-draw packaging machine 45, it is, for example, also possible to place the portions 43 on a material web 49 in which no depressions 53 have been formed so that the packaging spaces 52 in such embodiments may be defined, for example, by predetermined placement spaces on the material web 49. However, such packaging spaces 52 may subsequently in particular also be closed by an upper material web 57 to be able to produce closed packages. Furthermore, it may be provided that the packaging machine 45 is configured to provide respective packaging bases to be sealed, in particular so-called trays, wherein the transport device 61 may in particular have a picker robot to be able to insert the portions 43 into such packaging bases. In addition, the packaging machine 45 may be configured to seal the filled packaging bases.

To achieve processing results that are as optimal as possible in such a cyclical operation, it is necessary to precisely coordinate the processing devices 29 of the processing line 27 with one another so that the required number of portions 43 may always be provided at the intended time for a transfer to the packaging machine 45 and may be packaged accordingly. The slicing device 31 and the packaging machine 45 therefore have a respective processing device control unit 111 and 113, respectively, wherein settings of the slicing device 31 may be adjusted via the processing device control unit 111 and settings of the packaging machine 45 may be adjusted via the processing device control unit 113 to be able to achieve such a coordination. At the processing device control unit 111 of the slicing device 31, a display device 119 is furthermore schematically shown at which an operator may, for example, be shown respective settings of the slicing device 31 and control commands may possibly be received from the operator. The processing device control unit 113 may generally also have such a display device and a further processing device control unit, not shown here, may furthermore be provided for controlling the transport device 61.

However, in conventional plants 11, which only have the aforementioned processing device control units 111 and 113, the precise coordination of the settings of the processing devices 29 is usually undesirably complex since, for example, a change in a setting of the packaging machine 45 may require a corresponding change of a setting of the slicing device 31 (and/or of the transport device 61) that, however, has to take place at the separate processing device control unit 111. An operator of the processing line 27 must therefore constantly move between the different processing device control units 111 and 113 to be able to adjust the settings of the processing devices 29 and to coordinate them with one another. Furthermore, the operator of the processing line 27 must, for example, also move between the processing device control unit 111 and the packaging machine 45 to be able to check whether an adjustment of a setting of the slicing device 31 leads to a desired effect on the packaging machine 45. Furthermore, such processing lines 27 for processing food products 25 usually have to be operated in a production hall 69 that is cooled down to a cold temperature so that the control of a conventional processing line 27 may not only be laborious, but may also take place in an unpleasant working environment.

To address this problem, the plant 11 shown in FIG. 1 has a remote control device 65 that may be positioned spatially separately from the processing line 27 and that is configured to change a setting of at least one processing device 29 in response to a user input when the remote control device 65 is positioned spatially separately from the processing line 27. The remote control device 65 may in particular be configured to control all the processing devices 29 and therefore the processing line 27 as a whole.

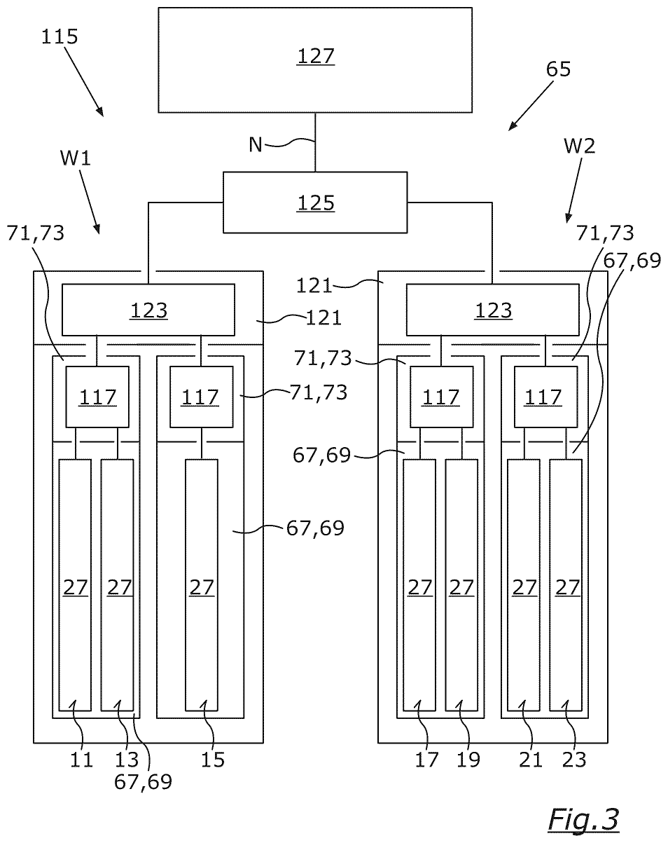

The remote control device 65 may thus make it possible to control the processing line 27 from a second room 71 in which the processing line 27 arranged in a first room 67 is not itself located. For example, it may be provided to arrange the remote control device 65 in a central control room 73, whereas the processing line 27 to be controlled is arranged in a production hall 69 so that the processing line 27 may in particular be controlled from a room 71 that does not have to be cooled down to the temperature of the production hall 69 (cf. also FIG. 3).

To enable a communication with the remote control device 65 and to be able to link the remote control device 65 and the processing line 27 to one another in a network N, the processing line 27 shown in FIG. 1 further has a radio module 77, wherein the remote control device 65 is configured, via a radio connection F to the radio module 77, to transmit a control command B to adjust a setting to the processing line 27 or a respective processing device 29. The remote control device 65 may in particular be configured to change settings of all the processing devices 29, i.e. settings of the slicing device 31, the transport device 61 and the packaging machine 45, by transmitting a corresponding control command B. In this respect, the control command B may in particular be transmitted to the remote control device 65 as a result of a corresponding user input.

Furthermore, FIG. 1 illustrates that the remote control device 65 may in particular have a stationary remote control unit 103 and may furthermore comprise a display device 87. For example, the stationary remote control unit 103 may be a computer and the display device 87 may be a monitor connected to the computer, wherein the stationary remote control unit 103 may, for example, be arranged in the aforementioned central control room 73 to be able to control the processing line 27 arranged in the production hall 69 from there. For example, the user input, in response to which the remote control device 65 changes a setting of at least one processing device 29, may be able to be entered at a keyboard and/or a mouse of such a computer. Via the radio connection F, the remote control device 65 may furthermore receive information I about settings of the processing line 27, wherein this information I may in particular be displayed at the display device 87 so that an operator of the remote control device 65 may always check the settings of the processing line 27.

To be able to further support the control of the processing line 27 by a remote control device 65 spatially separate from the processing line 27 and to also enable a remote control from those rooms from which the processing line 27 cannot be directly observed, the remote control device 65 is furthermore configured to receive a monitoring signal R from a monitoring device 99 arranged in the environment of the processing line 27, in particular a monitoring camera 101 arranged at the ceiling of the production hall 69, and to display image data, for example, transmitted by the monitoring camera 101 on the display device 87. This may enable an operator of the remote control device 65 to check the operation of the processing line 27 and, if necessary, to make adjustments to settings of the processing devices 29 without the operator having to have the processing line 27 directly in view.

Furthermore, it is shown that the remote control device 65 may be configured to send a control command B to the monitoring device 99 and, as a result, to control the monitoring device 99 to orient the monitoring camera 101 specifically to a region of the processing line 27, for example by changing a zoom factor and/or an orientation of the monitoring camera 101, and to be able to check the region in detail. The monitoring device 99 may also be linked to the remote control device 65 in the network N for this purpose and the remote control device 65 may be configured to transmit the control command B to the monitoring device 99 via a radio connection F, in particular a WLAN/WiFi connection.

Furthermore, the remote control device 65 may be configured to receive a monitoring signal R from a further monitoring device 100 that is arranged in the environment of the processing line 27 and that is configured as a thermometer 102 for measuring a temperature in the production hall 69 in which the processing line 27 is arranged. This may in particular enable an operator of the remote control device 65 to consider a current temperature of the production hall 69 when setting the processing line 27.

Furthermore, the remote control device 65 may comprise, as an alternative or in addition to the stationary control unit 103, a portable control unit 105 that is shown by way of example as a tablet. The portable control unit 105 may have a display device 107 and an input device 109 so that an operator of the portable control unit 105 may input control commands B for the processing line 27 at the input device 109 and may check current settings of the processing line 27 at the display device 107. In particular, the portable control unit 105 may have a combined input and display device that may in particular be configured as a touchscreen. The portable remote control unit 105 may also be linked to the processing line 27 via the network N and/or a radio connection F.

Such a portable control unit 105 may in particular enable an operator to move along the processing line 27 and to check the operation of the processing line 27, but to be able to adjust settings of respective processing devices 29 from any location. Therefore, the operator of the portable remote control unit 105 may, for example, check in the region of the feeder 63 whether the portions 43 are correctly transported to the packaging machine 45 and placed in packaging depressions 53 in order, however, if necessary, to adjust a setting of the slicing device 31 from there if the placement does not take place correctly. Furthermore, the operator may check the effect of such an adjustment directly at the feeder 63.

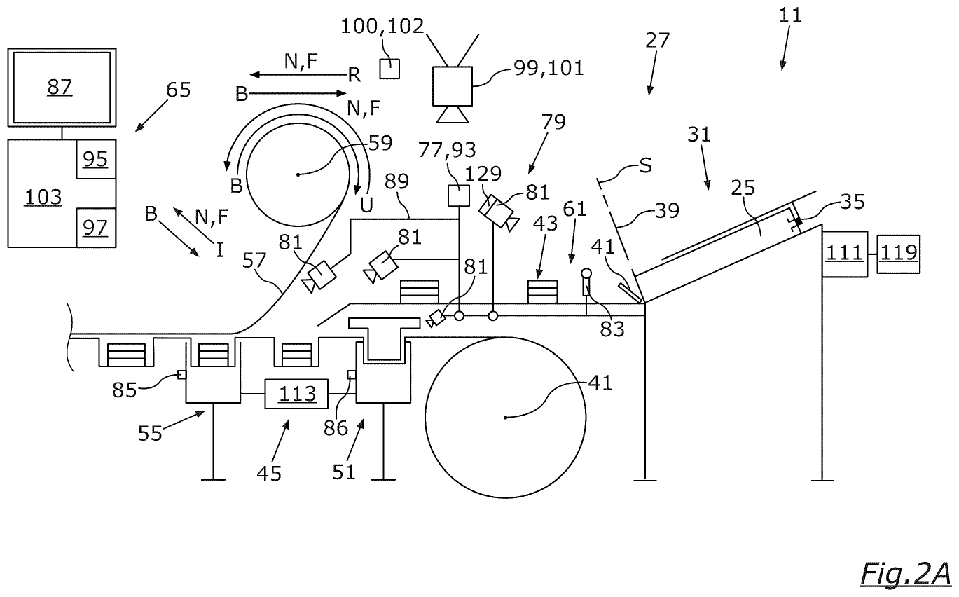

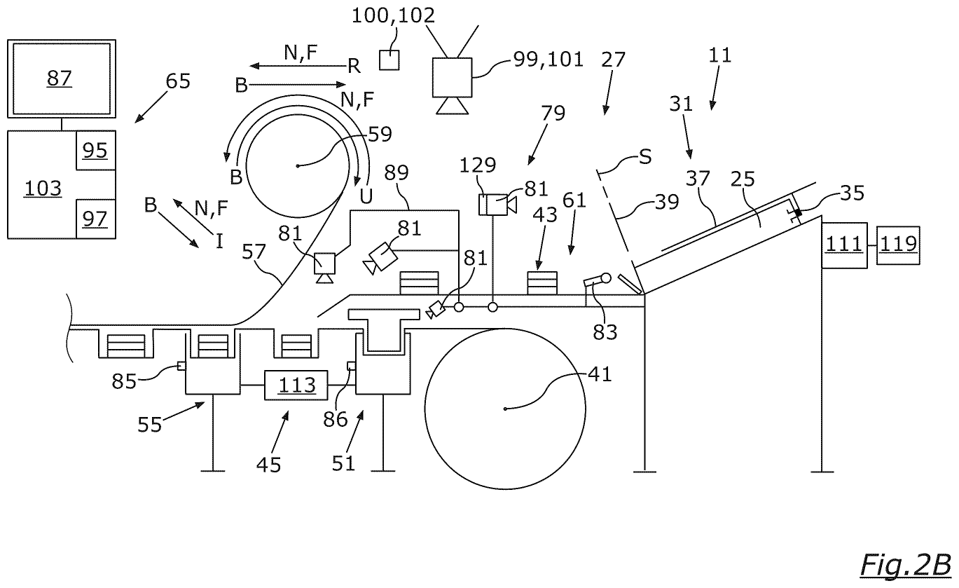

Furthermore, as FIG. 1 shows, the plant 11 has a coupling device 89 that is connected to the processing line 27 and that has a plurality of coupling elements 91 to which respective monitoring devices 81, 83 of a monitoring apparatus 79, which may be selectively arranged at the processing line 27, may be attached (cf. FIGS. 2A and 2B). Furthermore, the coupling device 89 has an interface 93 via which any monitoring devices 81, 83 attached to the coupling device 89 may be directly linked to the remote control device 65 so that information that may be acquired by means of coupled monitoring devices 81, 83 may be transmitted to the remote control device 65 and may be considered in the control of the processing line 27. In the embodiment shown, the interface 93 is in particular formed by the radio module 77 so that coupled monitoring devices 81, 83 may so-to-say be included in the network N and may transmit monitoring signals U to the remote control device 65.

As FIG. 2A illustrates, the monitoring apparatus 79 may in particular have a plurality of cameras 81 that may be selectively coupled to the coupling device 89 and may thereby be arranged at the processing line 27. The coupling device 89 thus so-to-say forms a docking point for such a monitoring set having a plurality of cameras 81 that may be selectively arranged at the processing line 27 in order to support or enable a remote control by the remote control device 65. On the other hand, the monitoring apparatus 79 and in particular the cameras 81 are not required for the operation of the plant 11 per se, but may merely be selectively arranged at the processing line 27 to support the remote control device 65.

Furthermore, the monitoring apparatus 79 also comprises, by way of example, a microphone 83 that may be selectively attached to the coupling device 89 in order, for example, to be able to detect any grinding noises of the blade 39 and to transmit them to the remote control device 65. In addition, a temperature sensor 85, which may be selectively arranged at the sealing station 55, and a pressure sensor 86, which may be selectively arranged at the molding station 51, are provided to be able to check a temperature at the sealing station 55 or a pressure developed at the molding station 51 and to be able to transmit corresponding information to the remote control device 65.

Since the coupling device 89 has the interface 93, the remote control device 65 may directly access the cameras 81, the microphone 83, the temperature sensor 85 and the pressure sensor 86 after a coupling to the monitoring apparatus 79. This may, for example, enable image data generated by a respective camera 81 to be displayed at the display device 87 so that an operator of the remote control device 65 may, for example, intentionally inspect and check a specific region of the processing line 27 by selecting a respective camera 81. For example, in cases in which it is to be assumed that the slicing process does not take place properly and a setting of the slicing device 31 has to be adjusted, the operator may therefore select the image data of the camera 81 oriented to the slicing device 31 for a display on the display device 87 and may examine the slicing of the slices 41 and the formation of portions 43.

While the remote control device 65 may receive the monitoring signal U from the monitoring apparatus 79 and in particular image data of the cameras 81, a temperature measured by the temperature sensor 85, a pressure measured by the pressure sensor 86 or an audio signal recorded by the microphone 83 via the radio connection F and the network N, on the one hand, the remote control device 65 is furthermore configured to transmit a control command B to the monitoring apparatus 79 and to thereby control the monitoring apparatus 79. As is illustrated by means of FIG. 2B, the remote control device 65 may in particular be configured to change a respective orientation of the cameras 81 and/or the microphone 83 to be able to orient the cameras 81 or the microphone 83 to different regions of the processing line 27 and to be able to intentionally check these regions. Provision may also be made to adjust a zoom factor of one or more cameras 81 by transmitting a corresponding control command B in order, for example, to be able to inspect various details at the processing line 27.

Moreover, in some embodiments, the monitoring apparatus 79 may have, as an alternative or in addition to the monitoring devices 81, 83 that may be selectively attached to the coupling device 89, further monitoring devices that may only be arranged in the environment of the processing line 27, but that may not be mechanically connected to the processing line 27. For example, it may be provided that the monitoring apparatus 79 has a further camera that may be connected to the remote control device 65 via the network N and that may be positioned in the environment of the processing device such that the operation of the processing line 27 as a whole may be checked in an overview-like manner using image data generated by the camera.

Furthermore, it is shown in FIGS. 2A and 2B that the monitoring apparatus 79 has a flagging device 129 that is arranged at the cameras 81 oriented to the slicing device 81 and that is configured to flag an active state of the camera 81. For example, the flagging device 129 may be configured to generate a light signal when the camera 81 is switched on and is used to monitor the slicing device 31 in order to alert persons present in the environment of the processing line 27 to the monitoring. The further monitoring devices 81, 83 and 85 may possibly also be flagged accordingly in the event of an activation. Furthermore, in some embodiments, such light signals may alternatively or additionally also be displayed at a respective monitored processing device 29 to indicate the monitoring of the respective processing device 29.

In addition, the remote control device 65 has a memory 95 in which the information I received from the processing line 27 about settings of the processing line 27 and/or information received from the monitoring apparatus 79 on the basis of the monitoring signals U or settings of the monitoring apparatus 79 may be stored. It may also be provided to store settings of the monitoring device 99 or the monitoring camera 101 or information received from the monitoring device 99 or the monitoring camera 101 in the memory 95. Such a documentation may in particular make it possible to subsequently trace and analyze any errors in the processing of the food products 25. Furthermore, it may be provided to read out settings of an already installed processing line 27 from the memory 95 and to use them when setting a further processing line 27, for example, to be able to start a running in of the further processing line 27 with already approximately correct settings and to be able to optimize the settings starting from the settings of the already installed processing line 27.

FIG. 3 further illustrates a possibility of a networked control of a plant system 115 comprising a plurality of plants 11, 13, 15, 17, 19, 21 and 23 that have a respective processing line 27 controllable by a remote control device 65.

FIG. 3 first schematically shows a first factory complex W1 that comprises two production halls 69, wherein two processing lines 27 of plants 11 and 13 are arranged in one production hall 69 and a further processing line 27 of a plant 15 is arranged in the other production hall 69. The processing lines 27 are connected to a local control device 117, which forms a part of the remote control device 65, via a network N, wherein the local control devices 117 are arranged in respective central control rooms 73, from which the processing lines 27, which are arranged in the respective associated production hall 69 and are thus positioned spatially separately from the control devices 117, may be controlled. Consequently, the processing lines 27 are located in a first room 67 of the respective production hall 69, whereas the local control devices 117 are positioned in a respective second room 71, the central control room 73. However, the local control devices 117 are configured to control the associated processing lines 27 and therefore enable a remote control of the processing lines 27 from the central control rooms 73. Furthermore, an interaction may take place between an operator of a local control device 117 and an operator located in the immediate vicinity of the associated processing line 27, wherein a communication may, for example, take place via the aforementioned processing device control units 111 and/or 113.

Furthermore, the local control devices 117 are connected to a factory control device 123 that is arranged in a factory control room 121 of the factory complex W1. As part of the remote control device 65, the factory control device 123 may be configured to transmit a control command B to the local control devices 117, which control command may be displayed on respective display devices of the local control device 117 or may be directly implemented to control the associated processing lines 27. Furthermore, it may be provided that the factory control device 123 is configured to control the processing lines 27 while bypassing the respective local control devices 117. Such a control of the processing lines 27 via a central factory control device 123 may in particular enable a bundling of competence in the factory control room 121 in that a plurality of persons responsible for controlling respective processing lines 27 may, for example, exchange information there in order to achieve the most ideal possible control of the respective processing lines 27.

In addition, the factory control device is connected via the network N to an external remote control unit 125 that is locally separate from the factory complex W1, wherein the external remote control unit 125 may in turn be configured to control the processing lines 27 in the factory complex W1. Such a connection may in particular make it possible to at least temporarily transfer the control of the processing lines 27 in the factory complex W1 to an external service provider so that such an external service provider may, for example, take over the running in of the processing lines 27 in the factory complex W1 or, in the event of staff absence due to illness, the control of the processing lines 27. The external service provider may therefore control the processing lines 27 of the factory complex W1 by means of the external remote control unit 125, which is positioned locally separately from the processing lines 27 and outside the factory complex W1, without having to specifically travel to the factory complex W1.

To enable such a remote control by an external service provider, it may in particular be provided to arrange the aforementioned monitoring apparatus at the respective processing line 27 for a time period during which the service provider takes over the control of a processing line 27. The service provider may thereby receive the monitoring signals U generated by the monitoring apparatus 79 via the network N or the radio connection F and may observe and check the operation of the processing line 27 at the external remote control unit 125 positioned locally separately from the processing line 27 to be controlled. If necessary, the monitoring apparatus 79 may therefore be removed again after the control has been ended by the service provider and after the control has been taken over by the owner of the processing line, who may, for example, observe the processing line 27 from the production hall 69 or the control room 73, and/or the monitoring apparatus 79 may be offered by the service provider as a monitoring set to be flexibly used and may be rented out, for example.

Furthermore, it may be provided that a control by the external remote control unit 125 may be enabled and/or requested, for example from the factory control device 123, so that the external service provider may generally not have access to the processing lines 27, but such an access must be explicitly granted.

The external remote control unit 125 is further connected to a factory control device 123 of a further factory complex W2 that likewise has two production halls 69 with, however, a total of four processing lines 27 of respective plants 17, 19, 21 and 23. The external remote control unit 125 may thus be configured to control processing lines 27 of different factory complexes W1 and W2 as part of the remote control device 65. In this regard, a bundling of competence and expertise may take place at the external remote control unit 125, for example, by considering settings of processing lines 27 from different factory complexes W1 and W2 and using them when setting a respective processing line 27.

Furthermore, the external remote control unit 125 is connected via the network N to a manufacturer remote control unit 127 as a further part of the remote control device 65. This may also enable a manufacturer of the processing lines 27 to take over the control of the processing lines 27, if necessary, and, for example, to assist in resolving an unusual problem in the operation of the processing lines 27. Since the control of the processing lines 27 via the manufacturer remote control unit 127 in this respect enables a remote control of the processing line 27, it is not necessary for the manufacturer to send its own service personnel to the processing lines 27, but a support in the control of processing lines 27 may take place at any time via the remote control device 65 or the manufacturer remote control unit 127 and thus locally separately from the processing line 27. For this purpose, it may in particular also be provided to arrange the monitoring apparatus 79 at a processing line 27 to be controlled temporarily via the remote control device 65 so that, for example, a manufacturer operating the manufacturer remote control unit 127 may obtain an overview of the respective processing line 27 to be controlled and may intentionally investigate possibly occurring problems by controlling the monitoring apparatus.

While embodiments of plants 11 that have a processing line 27 having a plurality of processing devices 29 have been explained with reference to the Figures, such a remote control may generally also be provided in plants 11 that comprise only a single processing device 29 and that are configured, for instance, as a slicing device 31 that is not integrated into a processing line 27 but is operated separately. Furthermore, such a remote control may also be provided in plants 11 that have a different selection of a plurality of processing devices 29 than the processing lines 27 of the plants 11 illustrated by means of the Figures. Processing devices 29 not shown in the Figures, for instance pressing devices or cheese dividers, may also be included by plants 11 within the scope of the present disclosure and/or integrated into processing lines 27 of such plants 11.

### Reference Numeral List

11 plant

13 plant

15 plant

17 plant

19 plant

21 plant

23 plant

25 food product

27 processing line

29 processing device

31 slicing device

33 product feed

35 gripper

37 guide

39 blade

41 slice

43 portion

45 packaging machine

47 material web roll

49 material web

51 molding station

52 packaging space

53 depression

55 sealing station

57 upper material web

59 roll

61 transport device

63 feeder

65 remote control device

67 first room

69 production hall

71 second room

73 control room

77 radio module

79 monitoring apparatus

81 camera

83 microphone

85 temperature sensor

86 pressure sensor

87 display device

89 coupling device

91 coupling element

93 interface

95 memory

97 radio module

99 monitoring device

100 further monitoring device

101 monitoring camera

102 thermometer

103 remote control unit positioned in a stationary manner

105 portable remote control unit

107 display device

109 input device

111 processing device control unit

113 processing device control unit

115 plant system

117 local control device

119 display device

121 factory control room

123 factory control device

125 external remote control unit

127 manufacturer remote control unit

129 flagging device

B control command

F radio connection

I information

N network

R further monitoring signal

S cutting plane

U monitoring signal

W1 first factory complex

W2 second factory complex

1-52. (canceled)

53. A plant for processing food products comprising:
at least one processing device; and
a remote control device that is positioned spatially separately from the at least one processing device,
wherein the remote control device positioned spatially separately from the at least one processing device is configured to change a setting of the at least one processing device in response to a user input.

54. The plant of claim 53,
wherein the at least one processing device is positioned in a first room and wherein the remote control device is configured to be positioned in a second room that is different from the first room,
wherein the remote control device, when positioned in the second room, is configured to change the setting of the at least one processing device positioned in the first room in response to the user input.

55. The plant of claim 53,
wherein the plant has at least one monitoring apparatus that is configured to be selectively arranged at the at least one processing device,
wherein the remote control device is configured to receive at least one monitoring signal from the at least one monitoring apparatus arranged at the at least one processing device.

56. The plant of claim 55,
wherein the at least one monitoring apparatus comprises at least one of a camera, an acceleration sensor, a microphone, a temperature sensor, or a pressure sensor.

57. The plant of claim 55,
wherein the remote control device has a display device configured to display information transmitted by the at least one monitoring signal.

58. The plant of claim 55,
wherein the remote control device is configured to control the at least one monitoring apparatus arranged at the plant.

59. The plant of claim 55,
wherein the at least one monitoring apparatus comprises at least one camera,
wherein the remote control device has a display device, and
wherein the display device is configured to display image data received from the at least one camera.

60. The plant of claim 59, wherein the remote control device is configured to control the at least one camera.

61. The plant of claim 55, wherein the plant has at least one coupling device for coupling the at least one monitoring apparatus.

62. The plant of claim 61, wherein the at least one coupling device has an interface for coupling the at least one monitoring apparatus to the remote control device.

63. The plant of claim 55,
wherein at least one of the at least one monitoring apparatus or the at least one processing device comprises a flagging device that is configured to flag at least one of an active monitoring device of the at least one monitoring apparatus or the at least one processing device in an event of a monitoring by the at least one monitoring apparatus.

64. The plant of claim 53,
wherein the remote control device is configured to be connected to a monitoring device that is positioned in an environment of the at least one processing device but is not arranged directly at the plant, and
wherein the remote control device is configured to at least one of receive or display a further monitoring signal from the monitoring device.

65. The plant of claim 64,
wherein the monitoring device positioned in the environment of the at least one processing device is a monitoring camera for monitoring a production hall.

66. The plant of claim 64,
wherein the remote control device is configured to control the monitoring device positioned in the environment of the at least one processing device.

67. The plant of claim 53,
wherein a control of the at least one processing device by the remote control device is configured to be at least one of requested or enabled.

68. The plant of claim 53, further comprising a processing line comprising the at least one processing device, wherein the at least one processing device comprises a plurality of processing devices including:
at least one slicing device having a product feed and at least one blade arranged in a cutting plane,
wherein the product feed is configured to guide the food products on one track or multiple tracks into the cutting plane, and
wherein the at least one blade is configured to cut off slices from the food products guided into the cutting plane in order to form portions,
wherein a portion comprises one or more of the slices;
a packaging machine that is configured to provide respective packaging spaces for the portions and to package the portions brought onto the respective packaging spaces; and
a transport device that is configured to transport the portions from the at least one slicing device to the packaging machine and to bring the portions onto the respective packaging spaces,
wherein the remote control device is configured to change the setting of at least one of the plurality of processing devices of the processing line in response to the user input

69. The plant of claim 53, wherein the at least one processing device is configured as:
a slicing device having a product feed and at least one blade arranged in a cutting plane, wherein the product feed is configured to guide the food products on one track or multiple tracks into the cutting plane, and wherein the at least one blade is configured to cut off slices from the food products guided into the cutting plane in order to form portions, wherein a portion comprises one or more of the slices;
a packaging machine that is configured to provide respective packaging spaces for the portions of the food products and to package the portions brought onto the respective packaging spaces;
a transport device that is configured to transport the portions from the slicing device to the packaging machine and to bring the portions onto the respective packaging spaces provided by the packaging machine;
a pressing device for pressing or shaping the food products;
a first device for providing web-like interleaved sheet material at a cutting region of the slicing device and comprising:
an unrolling device for removing a material web from a material web roll; and
an ejection device for dynamically ejecting the material web into the cutting region;
a cheese divider that is configured to divide a bar-shaped cheese product into a plurality of partial products; or
a second device for providing a portion support at the transport device for transporting the portions of the food products to the packaging machine, the second device comprising:
a store in which a stack of a plurality of portion supports is configured to be stored; and
a removal device that is configured to remove a respective upper portion support from the store and to provide the respective upper portion support at the transport device such that a food portion can be placed on the respective upper portion support during the transport by the transport device.

70. A plant system comprising:
at least a first plant for processing a first plurality of food products and comprising at least one first processing device; and
at least a second plant for processing a second plurality of food products and comprising at least one second processing device; and
a remote control device configured to be positioned spatially separately from the at least one first processing device and spatially separately from the at least one second processing device,
wherein the remote control device is configured to change at least one first setting of the at least one first processing device and at least one second setting of the at least one second processing device in response to a respective user input when positioned spatially separately from the at least one first processing device and the at least one second processing device.

71. The plant system of claim 70,
wherein the first plant and the second plant are positioned in a common production hall, in a common factory complex, or locally separately from one another in different factory complexes.

72. The plant system of claim 70,
wherein the remote control device is configured to at least one of receive or display at least one monitoring signal from a monitoring apparatus that is selectively arranged at at least one of the first plant or the second plant.

73. The plant system of claim 70,
wherein the remote control device is configured to be connected to a monitoring device that is positioned in an environment of at least one of the first plant or the second plant, and
wherein the remote control device is configured to at least one of receive or display a further monitoring signal from the monitoring device.

74. The plant system of claim 70,
wherein the remote control device is configured to:
receive information about settings of the at least one first processing device; and
set the at least one second processing device in accordance with the information.

75. A method for controlling a plant for processing food products, said plant comprising at least one processing device, the method comprising:
transmitting to a remote control device positioned spatially separately from the at least one processing device at least one of:
at least one monitoring signal of a monitoring apparatus that is selectively arranged at the at least one processing device; or
at least one monitoring signal of a monitoring device that is arranged in an environment of the plant; and
changing at least one setting of the at least one processing device by a user input at the remote control device positioned spatially separately from the at least one processing device, in consideration of the at least one monitoring signal.

76. The method of claim 75, wherein the monitoring apparatus is at least one of:
arranged at the at least one processing device for preparing the remote control of the at least one processing device, or
removed from the at least one processing device after the remote control has ended.

77. The method of claim 75,
wherein the monitoring apparatus is controlled by the remote control device that is positioned spatially separately from the at least one processing device.

78. The method of claim 75,
wherein at least one of an active monitoring device of the monitoring apparatus or the at least one processing device is flagged in an event of a monitoring by the monitoring apparatus.

79. The method of claim 75,
wherein the monitoring device arranged in the environment of the at least one processing device is controlled by the remote control device.
